(19) United States
(12) Patent Application Publication
(10) Pub. No.: US 2014/0358323 A1
(43) Pub. Date: Dec. 4, 2014

(54) APPARATUS AND METHOD FOR DETERMINING SHORT-TERM DRIVING TENDENCY OF DRIVER

(71) Applicants: Kia Motors Corporation, Seoul (KR); Hyundai Motor Company, Seoul (KR)

(72) Inventors: Byeong Wook JEON, Seoul (KR); Dong Hoon JEONG, Osan-si (KR)

(73) Assignees: Kia Motors Corporation, Seoul (KR); Hyundai Motor Company, Seoul (KR)

(21) Appl. No.: 14/098,476

(22) Filed: Dec. 5, 2013

(30) Foreign Application Priority Data
May 30, 2013 (KR) 10-2013-0062039

(51) Int. Cl. F16H 59/00

(52) U.S. Cl. CPC F16H 59/00
USPC 701/1

(57) ABSTRACT

An apparatus for determining a short-term driving tendency of a driver according to the present invention includes a data detector configured to detect a vehicle speed and an inter-vehicle distance, and a controller configured to determine the short-term driving tendency of the driver on the basis of the vehicle speed and the inter-vehicle distance. The controller extracts fuzzy result values with respect to the vehicle speed and the inter-vehicle distance by setting a membership function that corresponds to each of the vehicle speed and the inter-vehicle distance, and determines the short-term driving tendency using the fuzzy result values.

### CROSS-REFERENCE TO RELATED APPLICATION

The present application claims priority of Korean Patent Application Number 10-2013-0062039 filed on May 30, 2013, the entire contents of which application are incorporated herein for all purposes by this reference.

### BACKGROUND OF INVENTION

1. Field of Invention

The present invention relates to an apparatus and a method for determining a short-term driving tendency of a driver, and more particularly, to an apparatus and a method for determining a short-term driving tendency of a driver using a vehicle speed and an inter-vehicle distance.

2. Description of Related Art

Satisfaction of customers regarding running performance of a vehicle depends on how a vehicle runs and coincides with a driving tendency of the driver. While tendencies of the customers vary, however, performance characteristic of the vehicles is set to one performance characteristic in the same vehicle model. Therefore, reaction of the vehicle may not coincide with the tendency of the customer. Accordingly, customers frequently make a complaint about the running performance of the vehicle. That is, when the driving tendency of the customers is recognized, and shift is controlled so that the vehicle responds suitably to the driving tendency of the customers, the satisfaction of the customer regarding running performance may be maximized.

Accordingly, a method of learning the driving tendency of a customer over a short period of time and controlling the shift in accordance with the learned driving tendency has been developed. The method of controlling the shift in accordance with the learned driving tendency is performed under an assumption that the driving tendencies of the drivers are uniform. However, since the tendency of the driver is not always uniform, and may be changed in accordance with changes such as the mood of the driver, sudden changes in driving intention, a road condition, or the like, there is a great difference between the learned driving tendency and an actual tendency of a driver in certain environments. Accordingly, in a case in which shift is controlled in accordance with the learned driving tendency, the actual driving will of the driver may not be reflected on the shift and the driver may dissatisfy with the driving performance.

As a main parameter for determining an acceleration intention of a driver, an accelerator pedal opening degree (APS) and a change rate of an accelerator pedal opening degree (ΔAPS) were mainly used in the related art. However, even though a situation of manipulating the accelerator pedal is an important reference for determining the driver's acceleration intention, there is a limitation to express the overall driving intention of the driver. That is, in order to recognize the driving tendency in a situation of driving the vehicle instead of a situation of accelerating the vehicle, a more reasonable determination reference is required rather than the APS.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide an apparatus and a method for determining a short-term driving tendency of a driver, which may perform customized shift by accurately determining a short-term driving tendency of a driver for a short time (e.g., while a vehicle currently runs or during a predetermined time while the vehicle currently runs).

Various aspects of the present invention provide an apparatus for determining a short-term driving tendency of a driver including a data detector configured to detect a vehicle speed and an inter-vehicle distance and a controller configured to determine the short-term driving tendency of the driver using the vehicle speed and the inter-vehicle distance, in which the controller extracts fuzzy result values with respect to the vehicle speed and the inter-vehicle distance by setting a membership function that corresponds to each of the vehicle speed and the inter-vehicle distance, and determines the short-term driving tendency using the fuzzy result values.

Further, the controller may determine from the fuzzy result values that the short-term driving tendency is a first tendency when the vehicle speed is equal to or less than a reference speed and the inter-vehicle distance is equal to or less than a predetermined distance, a second tendency when the vehicle speed exceeds the reference speed, and the inter-vehicle distance is equal to or less than the predetermined distance, and a third tendency when the inter-vehicle distance exceeds the predetermined distance

Meanwhile, the data detector may include a vehicle speed sensor mounted to a wheel of a vehicle, and measure the vehicle speed using the vehicle speed sensor. In addition, the data detector may include a GPS that is capable of determining a position of a vehicle, and calculate the vehicle speed using a GPS signal received from the GPS.

Various other aspects of the present invention provide a method for determining a short-term driving tendency of a driver including detecting a vehicle speed and an inter-vehicle distance, setting a membership function that corresponds to each of the vehicle speed and the inter-vehicle distance, extracting fuzzy result values with respect to the vehicle speed and the inter-vehicle distance, and determining the short-term driving tendency using the fuzzy result values.

The determining of the short-term driving tendency of the driver may include determining from the fuzzy result values that the short-term driving tendency is a first tendency when the vehicle speed is equal to or less than a reference speed, and the inter-vehicle distance is equal to or less than a predetermined distance, determining from the fuzzy result values that the short-term driving tendency is a second tendency when the vehicle speed exceeds the reference speed, and the inter-vehicle distance is equal to or less than the predetermined distance, and determining from the fuzzy result values that the short-term driving tendency is a third tendency when the inter-vehicle distance exceeds the predetermined distance.

The vehicle speed may be measured by a vehicle speed sensor mounted to a wheel of a vehicle, or calculated using a GPS signal received from a GPS that is capable of determining a position of a vehicle.

Other aspects of the present invention provide a method for determining a short-term driving tendency of a driver including detecting a vehicle speed and an inter-vehicle distance, setting a membership function for each of the vehicle speed and the inter-vehicle distance, extracting fuzzy result values with respect to the vehicle speed and the inter-vehicle distance, and determining the short-term driving tendency using the fuzzy result values.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a block diagram of an exemplary apparatus for determining a short-term driving tendency of a driver according to the present invention.

FIG. 2 is a flowchart of an exemplary method for determining a short-term driving tendency of a driver according to the present invention.

FIG. 3 is an exemplary view illustrating a membership function for determining a short-term driving tendency of a driver according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

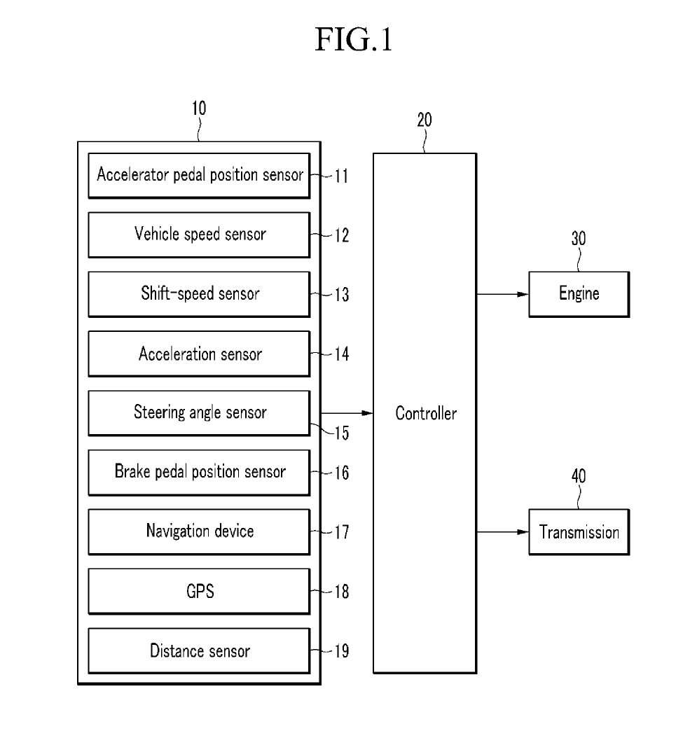

FIG. 1 is a block diagram of an apparatus for determining a short-term driving tendency of a driver according to various embodiments of the present invention. As illustrated, an apparatus for determining a short-term driving tendency of a driver includes a data detector 10, a controller 20, an engine 30, and a transmission 40.

The data detector 10 detects the short-term driving tendency of the driver and data for determining the short-term driving tendency, and the data measured by the data detector 10 is transmitted to the controller 20. The data detector 10 includes an accelerator pedal position sensor 11, a vehicle speed sensor 12, a shift-speed sensor 13, an acceleration sensor 14, a steering angle sensor 15, a brake pedal position sensor 16, a navigation device 17, a global positioning system (GPS) 18, and a distance sensor 19.

The accelerator pedal position sensor 11 measures how much the driver presses an accelerator pedal. That is, the accelerator pedal position sensor 11 measures data regarding the driver's intention of accelerating a vehicle. The vehicle speed sensor 12 measures a vehicle speed, and is mounted to a wheel of the vehicle. In some cases, a vehicle speed may be calculated on the basis of a GPS signal received by the GPS 18.

Meanwhile, a target shift-speed may be calculated on the basis of a signal of the accelerator pedal position sensor 11 and a signal of the vehicle speed sensor 12 using a shift pattern, and shift to the target shift-speed is controlled. That is, in the case of an automatic transmission including a plurality of planetary gear sets and a plurality of friction elements, hydraulic pressure, which is supplied to the plurality of friction elements or released from the plurality of friction elements, is adjusted. In addition, in the case of a double clutch transmission, a current, which is applied to a plurality of synchronizer devices and actuators, is controlled.

The shift-speed sensor 13 detects a shift-speed that is currently engaged. The acceleration sensor 14 detects acceleration of the vehicle. In addition to the vehicle speed sensor 12, the acceleration sensor 14 is mounted to directly detect acceleration of the vehicle, or acceleration of the vehicle may be calculated by differentiating the vehicle speed detected by the vehicle speed sensor 12.

The steering angle sensor 15 detects a steering angle of the vehicle. That is, the steering angle sensor 15 detects a direction in which the vehicle intends to run. The brake pedal position sensor 16 detects whether the brake pedal is pressed or not. That is, the brake pedal position sensor 16 detects the driver's intention of accelerating the vehicle together with the accelerator pedal position sensor 11.

The navigation device 17 is a device that informs the driver of a path to a destination. The navigation device 17 includes an input and output unit configured to input and output information on a route guide, a current position detector configured to detect information on a current position of the vehicle, a memory storing map data, which is necessary to calculate a route, and data, which is necessary to guide the driver, a control unit configured to perform a route search or a route guide, and the like.

The GPS 18 receives an electric wave transmitted from a GPS satellite, and transmits a signal regarding the electric wave to the navigation device 17. The distance sensor 19 detects a distance between the driver's vehicle and a forward vehicle. As the distance sensor 19, various sensors such as an ultrasonic wave sensor or an infrared sensor may be used.

The controller 20 determines the short-term driving tendency of the driver on the basis of the data detected by the data detector 10. To this end, the controller 20 may be implemented to include at least one processor that is operated by a predetermined program, and the predetermined program may be programmed in order to perform each step of a method for determining the short-term driving tendency of the driver according to various embodiments of the present invention.

Specifically, the controller 20 determines the short-term driving tendency of the driver for a comparatively short time on the basis of the data detected by the data detector 10. That is, the controller 20 may determine a driving tendency of the driver, for example, while the vehicle currently runs or during a predetermined time while the vehicle currently runs. The short-term driving tendency of the driver may be determined on the basis of how well one or a plurality of assumptions or conditions regarding a tendency of the driver is satisfied, and a fuzzy control theory may be used to determine the short-term driving tendency of the driver.

The controller 20 applies the fuzzy control theory to a vehicle speed and an inter-vehicle distance, and may set a membership function that corresponds to each of the vehicle speed and the inter-vehicle distance. Further, the controller 20 may calculate a fuzzy result value from the membership function of the measured vehicle speed and the measured inter-vehicle distance.

For example, the vehicle speed may be separately defined as or divided into a high state and a low state in accordance with the measured vehicle speed or the calculated vehicle speed. In addition, the inter-vehicle distance may be separately defined as or divided into a defensive state and an aggressive state in accordance with the measured distance from the forward vehicle.

Further, the controller 20 may determine the short-term driving tendency of the driver using the membership function set for the vehicle speed and the inter-vehicle distance.

Meanwhile, the controller 20 may determine a condition of a road on which the vehicle currently runs on the basis of the data detected by the data detector 10. The condition of the road includes a specific road state such as an icy road, a slippery road, a rough road, and an unpaved road, a specific road shape such as a curved road and a slope road, and a congested degree. In the case of the specific road state, the specific road shape, or the congested road, it is general that the vehicle is not driven in accordance with the driving tendency of the driver, but runs in accordance with the condition of the road. Therefore, the short-term driving tendency of the driver is not calculated under the specific road condition such that the driving tendency of the driver may be accurately calculated.

In some cases, the short-term driving tendency of the driver may be calculated even under the specific road condition. In such cases, a filter, which is strong against the short-term driving tendency of the driver calculated under the specific road condition, may be applied.

In addition, the controller 20 controls the engine 30 or the transmission 40 in accordance with a short-term driving tendency index of the driver. That is, the controller 20 may change a shift pattern, engagement feeling toward a target shift-speed, an engine torque map, and/or an engine torque filter in accordance with the short-term driving tendency index.

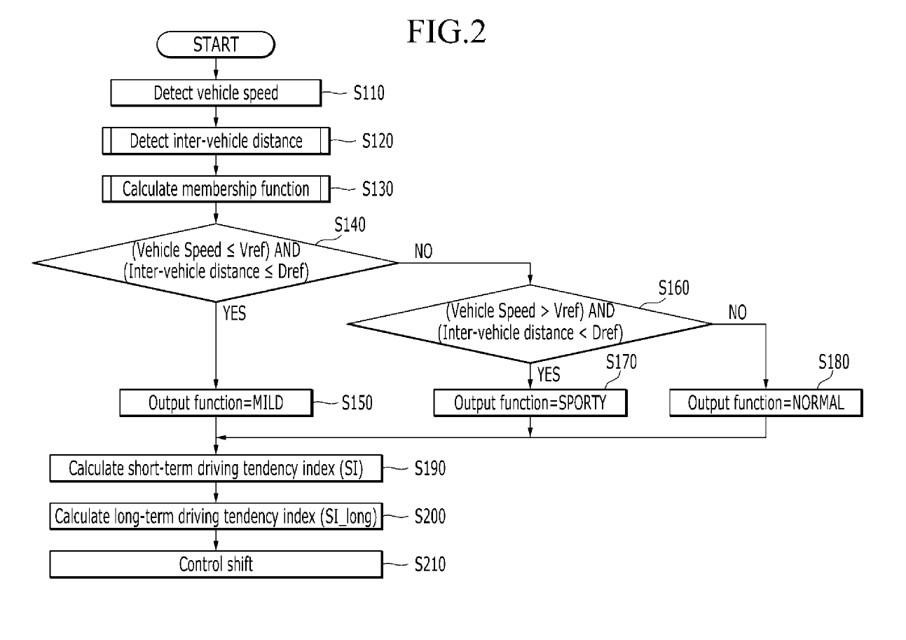

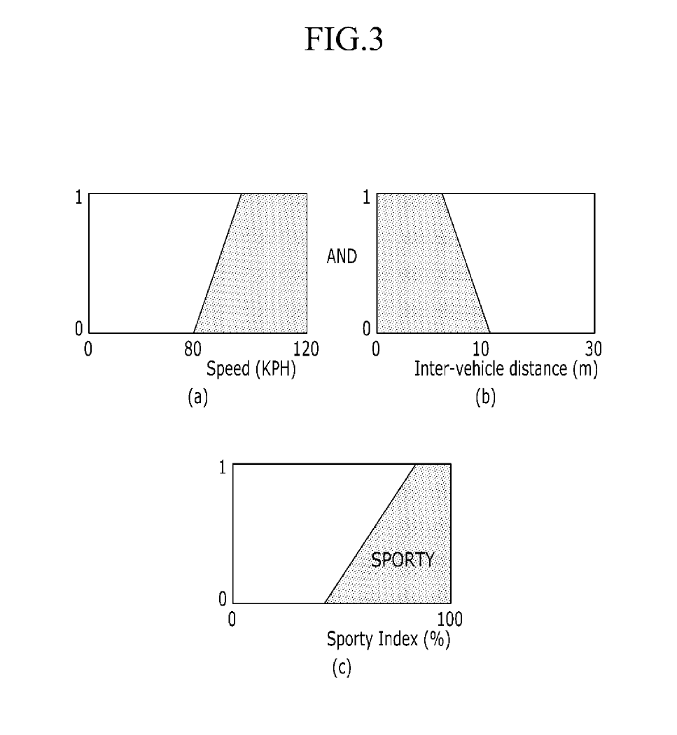

Hereinafter, a method for determining the short-term driving tendency of the driver will be described in detail with reference to FIGS. 2 and 3. FIG. 2 is a flowchart of a method for determining the short-term driving tendency of the driver, and FIG. 3 is an exemplary view illustrating the membership function for determining the short-term driving tendency of the driver according to various embodiments of the present invention.

As shown in FIG. 2, the data detector 10 detects a vehicle speed (S110). For example, the vehicle speed may be measured by the vehicle speed sensor 12 mounted to the wheel of the vehicle, or the vehicle speed may be calculated on the basis of a GPS signal received from the GPS 18. In addition, the data detector 10 detects the inter-vehicle distance (S120). The distance sensor 19 may detect a distance between the driver's vehicle and the forward vehicle. Steps S110 and S120 may be simultaneously performed, or may be separately performed regardless of the sequence.

Next, after the data detector 10 detects the vehicle speed and the inter-vehicle distance, and then transmits the vehicle speed and the inter-vehicle distance to the controller 20, the controller 20 calculates the membership function in which the vehicle speed and the inter-vehicle distance are used as variables (S130). The vehicle speed and the inter-vehicle distance used as variables for calculation may be values that are measured by the data detector 10 for a predetermined time and transmitted from the data detector 10.

The controller 20 determines whether the vehicle speed is equal to or less than a reference speed, and the inter-vehicle distance is equal to or less than a predetermined distance (S140). Further, when it is determined that the vehicle speed is equal to or less than the reference speed, and the inter-vehicle distance is equal to or less than the predetermined distance, the controller 20 determines that the short-term driving tendency of the driver is a first tendency (mild) (S150).

In step S140, if the vehicle speed exceeds the reference speed, or the inter-vehicle distance exceeds the predetermined distance, the controller 20 determines whether the vehicle speed exceeds the reference speed, and the inter-vehicle distance is equal to or less than the predetermined distance (S160). Further, when it is determined that the vehicle speed exceeds the reference speed, and the inter-vehicle distance is equal to or less than the predetermined distance, the controller 20 determines that the short-term driving tendency of the driver is a second tendency (sporty) (S170).

Finally, in step S160, if the inter-vehicle distance exceeds the predetermined distance, the controller 20 determines that the short-term driving tendency of the driver is a third tendency (normal) (S180).

Thereafter, the controller 20 calculates a short-term driving tendency index (SI) at each time point (S190). In addition, an average of the short-term driving tendency indexes for a predetermined time Ti is calculated and stored as a short-term driving tendency index (SI_Avg) for a predetermined time. That is, the short-term driving tendency index (SI_Avg) for a predetermined time is calculated by the following Equation 1.

$$SI\_Avg = \frac{{\sum }_{t = {t}_{0}}^{{t}_{0} + {T}_{1} ( se c )} SI}{{T}_{1} ( sec )} \qquad Equation 1$$

After the short-term driving tendency index for a predetermined time is calculated in step S190, the controller 20 calculates a long-term driving tendency index (SI_long) from recent n short-term driving tendency indexes using the following Equation 2 (S200).

$$SI\_long = \frac{{\sum }_{i = 1}^{n} {SI\_Avg}_{n - i + 1} \times {W}_{i}}{{nT}_{1}} \qquad Equation 2$$

Here, SI_Avgi refers to an i-th short-term driving tendency index, and Wi refers to an i-th weight value. In addition, a sum of n weight values is 1, and the i-th weight value may be equal to or less than an (i+1)-th weight value. By allowing the (i+1)-th weight value to be equal to or greater than the i-th weight value, the most recent short-term driving tendency index most greatly influences the long-term driving tendency index.

While the present specification discloses one exemplary method of calculating the short-term driving tendency index and the long-term driving tendency index, it should be understood that the method of calculating the short-term driving tendency index and the long-term driving tendency index is not limited to the exemplary methods disclosed in the present specification.

After the long-term driving tendency index of the driver is calculated in step S200, the controller 20 controls shift in accordance with the long-term driving tendency index (S210). That is, the controller 20 changes the engine torque map and/or the engine torque filter in accordance with the long-term driving tendency index, and controls the engine 30 in accordance with the changed engine torque map and/or the changed engine torque filter. In addition, the controller 20 changes the shift pattern and the engagement feeling toward the target shift-speed in accordance with the long-term driving tendency index, and controls the transmission 40 in accordance with the changed shift pattern and the engagement feeling toward the target shift-speed.

Hereinafter, the membership function with respect to the vehicle speed and the inter-vehicle distance will be described with reference to FIG. 3. FIG. 3 is an exemplary view illustrating the membership function for determining the short-term driving tendency of the driver according to various embodiments of the present invention.

When the vehicle speed exceeds the reference speed, the controller 20 may express the vehicle speed as an input membership function in a high state, as illustrated in FIG. 3A. Further, when the inter-vehicle distance is equal to or less than the predetermined distance, the controller 20 may express the inter-vehicle distance as an input membership function in an aggressive state, as illustrated in FIG. 3B.

Further, as illustrated in FIG. 3C, the controller 20 may output a fuzzy result value using both input membership functions. For example, when the input membership function is inputted, the controller 20 outputs the fuzzy result value as the second tendency (sporty), and may determine that the short-term driving tendency of the driver is the second tendency (sporty).

An effect of the apparatus for determining the short-term driving tendency of the driver according to the present invention will be described below. According to at least one of various embodiments of the present invention, there is an advantage that the short-term driving tendency of the driver is easily calculated from the inter-vehicle distance and the vehicle speed.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for determining a short-term driving tendency of a driver comprising:
a data detector configured to detect a vehicle speed and an inter-vehicle distance; and
a controller configured to determine the short-term driving tendency of the driver using the vehicle speed and the inter-vehicle distance,
wherein the controller extracts fuzzy result values with respect to the vehicle speed and the inter-vehicle distance by setting a membership function that corresponds to each of the vehicle speed and the inter-vehicle distance, and determines the short-term driving tendency using the fuzzy result values.

2. The apparatus of claim 1, wherein the controller determines from the fuzzy result values that the short-term driving tendency is:
a first tendency when the vehicle speed is equal to or less than a reference speed, and the inter-vehicle distance is equal to or less than a predetermined distance,
a second tendency when the vehicle speed exceeds the reference speed, and the inter-vehicle distance is equal to or less than the predetermined distance, and
a third tendency when the inter-vehicle distance exceeds the predetermined distance.

3. The apparatus of claim 1, wherein the data detector includes a vehicle speed sensor mounted to a wheel of a vehicle, and measures the vehicle speed using the vehicle speed sensor.

4. The apparatus of claim 1, wherein the data detector includes a GPS that is capable of determining a position of a vehicle, and calculates the vehicle speed using a GPS signal received from the GPS.

5. A method for determining a short-term driving tendency of a driver comprising:
detecting a vehicle speed and an inter-vehicle distance;
setting a membership function that corresponds to each of the vehicle speed and the inter-vehicle distance;
extracting fuzzy result values with respect to the vehicle speed and the inter-vehicle distance; and
determining the short-term driving tendency using the fuzzy result values.

6. The method of claim 5, wherein the determining of the short-term driving tendency of the driver includes:
determining from the fuzzy result values that the short-term driving tendency is a first tendency when the vehicle speed is equal to or less than a reference speed, and the inter-vehicle distance is equal to or less than a predetermined distance;
determining from the fuzzy result values that the short-term driving tendency is a second tendency when the vehicle speed exceeds the reference speed, and the inter-vehicle distance is equal to or less than the predetermined distance; and
determining from the fuzzy result values that the short-term driving tendency is a third tendency when the inter-vehicle distance exceeds the predetermined distance.

7. The method of claim 5, wherein the vehicle speed is measured by a vehicle speed sensor mounted to a wheel of a vehicle.

8. The method of claim 5, wherein the vehicle speed is calculated using a GPS signal received from a GPS that is capable of determining a position of a vehicle.
